(19) United States
(12) Patent Application Publication
(10) Pub. No.: US 2017/0169105 A1
(43) Pub. Date: Jun. 15, 2017

(54) DOCUMENT CLASSIFICATION METHOD

(71) Applicant: NEC Corporation, Tokyo (JP)

(72) Inventors: Daniel Georg ANDRADE SILVA, Tokyo (JP); Hironori MIZUGUCHI, Tokyo (JP); Kai ISHIKAWA, Tokyo (JP)

(73) Assignee: NEC Corporation, Tokyo (JP)

(21) Appl. No.: 15/039,347

(22) PCT Filed: Nov. 27, 2013
(86) PCT No.: PCT/JP2013/082515

§ 371 Date: May 25, 2016

(51) Int. Cl. G06F 17/30; G06F 17/18; G06N 99/00; G06F 17/11

(52) U.S. Cl. CPC G06F 17/30705; G06F 17/30663; G06F 17/30011; G06F 17/11; G06F 17/18; G06N 99/005

(57) ABSTRACT

A document classification method includes a first step for calculating smoothing weights for each word and a fixed class, a second step for calculating smoothed second-order word probability, and a third step for classifying document including calculating the probability that the document belongs to the fixed class.

### TECHNICAL FIELD

The present invention relates to a method to decide whether a text document belongs to a certain class R or not (i.e. any other class), where there are only few training documents available for class R, and all classes can be arranged in a hierarchy.

### BACKGROUND ART

The inventors of the present invention propose a smoothing technique that improves the classification of a text into two classes R and [symbol] R, whereas only a few training instances for class R are available. The class [symbol] R denote all classes that are class R, where all classes are arranged in a hierarchy. We assume that we have access to training instances of several classes that subsume class R.

This kind of problem occurs, for example, when we want to identify whether a document is about region (class) R, or not. For example, region R contains all geo-located Tweets (refer to messages from www.twitter.com) that belong to a certain city R, and outer regions S₁ and S₂ refer to the state, and the country, respectively, where city R is located. It is obvious that the classes R, S₁ and S₂ can be thought of being arranged in a hierarchy, where S₁ subsumes R, and S₂ subsumes S₁. However, most Tweets do not contain geo-location, i.e., we do not know whether the text messages were about region R. Given a small set of training data, we want to detect whether the text was about city R or not. In general, we have only a few training data instances available for city R, but much training data instances available for region S₁ and S₂.

Non-Patent Document 1 proposes for this task to use a kind of Naive Bayes classifier to decide whether a Tweet (document) belongs to region R. This classifier uses the word probabilities p(w|R) for classification (actually they estimate p(R|w), however, this difference is irrelevant here). In general R is small, and only a few training instance documents that belong to region R are available. Therefore, the word probabilities p(w|R) cannot be estimated reliable. In order to overcome this problem, they suggest to use training instance documents that belong to a region S that contains R.

Since S contains, in general, more training instances than R, Non-Patent Document 1 proposes to smooth the word probabilities p(w|R) by using p(w|S). For the smoothing they suggest to use a linear combination of p(w|R) and p(w|S), where the optimal parameter for the linear combination is estimated using held-out data.

This problem setting is also similar to hierarchical text classification. For example, class R is “Baseball in Japan”, class S₁ is class “Baseball” and S₂ is class “Sports”, and so forth. For this problem Non-Patent Document 2 suggests to smooth the word probabilities p(w|R) for class R by using one or more hyper-classes that contain class R. A hyper-class S has, in general, more training instances than class R, and therefore we can expect to get more reliable estimates. However, hyper-class S might also contain documents that are completely unrelated to class R. Non-Patent Document 2 relates to this dilemma as the trade-off between reliability and specificity. They solve this trade-off by setting weight λ that interpolates p(w|R) and p(w|S). The optimal weight λ needs to be set using held-out data.

### Document of the Prior Art

Non-Patent Document 1: “You Are Where You Tweet: A Content-Based Approach to Geo-locating Twitter Users”, Z. Cheng et. al., 2010.

Non-Patent Document 2: “Improving text classification by shrinkage in a hierarchy of classes”, A. McCallum et al., 1998.

### DISCLOSURE OF INVENTION

### Problems to be Solved by the Invention

All previous methods require the use of held-out data 2 to estimate the degree of interpolation between p(w|R) and p(w|S), as shown in FIG. 1. However, selecting a subset of training data instances of R (held-out data) reduces the data that can be used for training even further. This can out-weight the benefits that can be gained from setting the interpolation parameters with the held-out data. This problem is only partly mitigated by cross-validation, which, furthermore, can be computationally expensive. In FIG. 1, X<=Y means document set Y contains document set X. Due to the analogy of geographic regions, we use the term “region”, instead of the term “category” or “class”.

It might appear that another obvious solution, would be to use the same training data twice, once for estimating the probability p(w|R) and once for estimating the optimal weight λ. However, using the approaches like described Non-Patent Document 1 or Non-Patent Document 2, would simply set the weight of λ to 1 for p(w|R) , and zero for p(w|S). This is because their method requires point-estimates of p(w|R) , which is a maximum-likelihood or maximum-a posterior estimate, that cannot measure the uncertainty of the estimate of p(w|R).

### Means for Solving the Problem

Our approach compares the distributions of p(w|R) and p(w|S) and use the difference to decide if and how, the distribution p(w|R) should be smoothed using only the training data. The assumption of our approach can be summarized as follows: If the distribution of a word w is similar in region R and its outer region S, we expect that we can get a more reliable estimate of p(w|R) that is close to the true p(w|R) by using the sample space of region S. On the other hand, if the distributions are very different, we expect that we cannot do better than using the small sample size of R. The degree to which we can smooth the distribution p(w|R) with the distribution p(w|S) is determined by how likely it is that the training data instance of region R were generated by the distribution p(w|S). We denote this likelihood as p(D_{R}|D_{S}). If, for example, we assume that the word occurrences are generated by a Bernoulli Trial, and we use as conjugate prior the Beta distribution, then the likelihood p(D_{R}|D_{S}) can be calculated as the ratio of two Beta functions. In general, if the word occurrences are assumed to be generated by an i.i.d sample of distribution P with parameter vector θ, and conjugate prior f over the parameters θ, then the likelihood p(D_{R}|D_{S}) can be calculated as a ratio of the normalization constants of two distributions of type f.

To make the uncertainty about the estimates p(w|R) (and p(w|S)) clear, we model the probability over these probabilities. For example, in case we assume that word occurrences are model by a Bernoulli distribution, we chose as the conjugate prior the beta distribution, and derive therefore beta distribution for the probability over p(w|R) (and p(w|S)). For each probability over probability p(w|S) (there is one for each Sε{R, S₁, S₂, . . . }), we select the one which results in the highest likelihood of the data p(D_{R}|D_{S}). We select this probability as the smoothed second-order word probability for p(w|R).

A variation of this approach is to first create mutual exclusive subsets R, G₁, G₂, . . . from the set {R, S₁, S₂, . . . }, and then calculate a weighted average of the probabilities over probability p(w|G), where the weights correspond to the data likelihood p(D_{R}|D_{G}).

In the final step, for a new document d we calculate the probability that document d belongs to class R, by using the probability over probability p(w|R). For example, we use the naive Bayes assumption, and calculate p(d|R) by probability over probability p(w|R) (Bayesian Naive Bayes).

### Effect of the Invention

The present invention has the effect of smoothing the probability that a word w occurs in a text that belongs to class R by using the word probabilities of outer-classes of R. It achieves this without the need to resort to additional held-out training data.

### BRIEF DESCRIPTION OF THE DRAWINGS

FIG. 1 is a block diagram showing the functional structure of the system proposed by previous work.

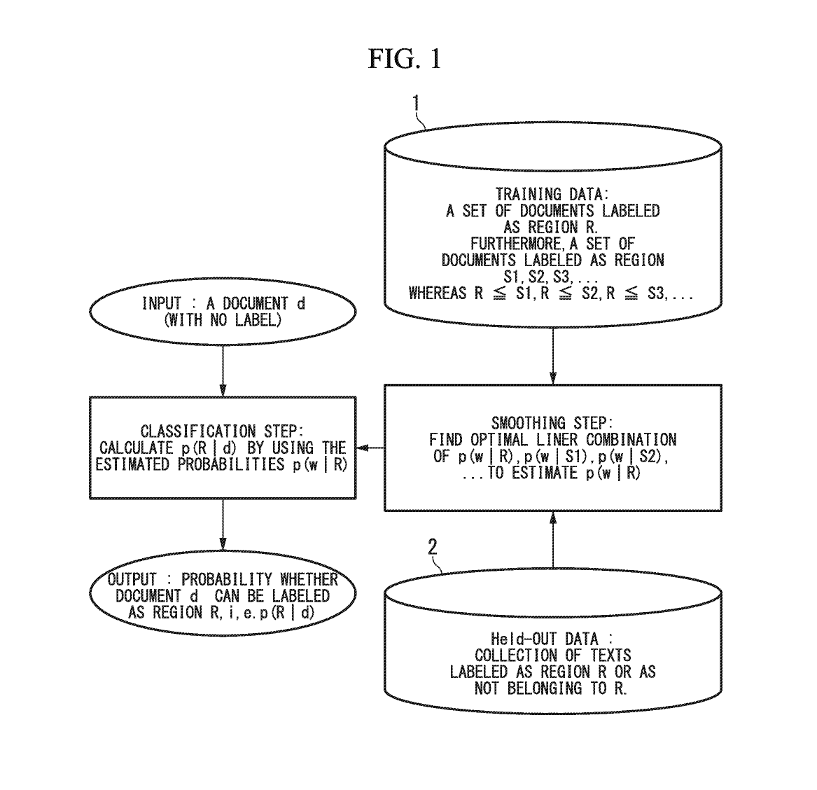

FIG. 2 is a block diagram showing a functional structure of a document clarification system according to a first exemplary embodiment of the present invention.

FIG. 3 is a block diagram showing a functional structure of a document clarification system according to a second exemplary embodiment of the present invention.

FIG. 4 shows an example related to the first embodiment.

FIG. 5 shows an example related to the second embodiment.

### EXEMPLARY EMBODIMENTS FOR CARRYING OUT THE INVENTION

### First Exemplary Embodiment

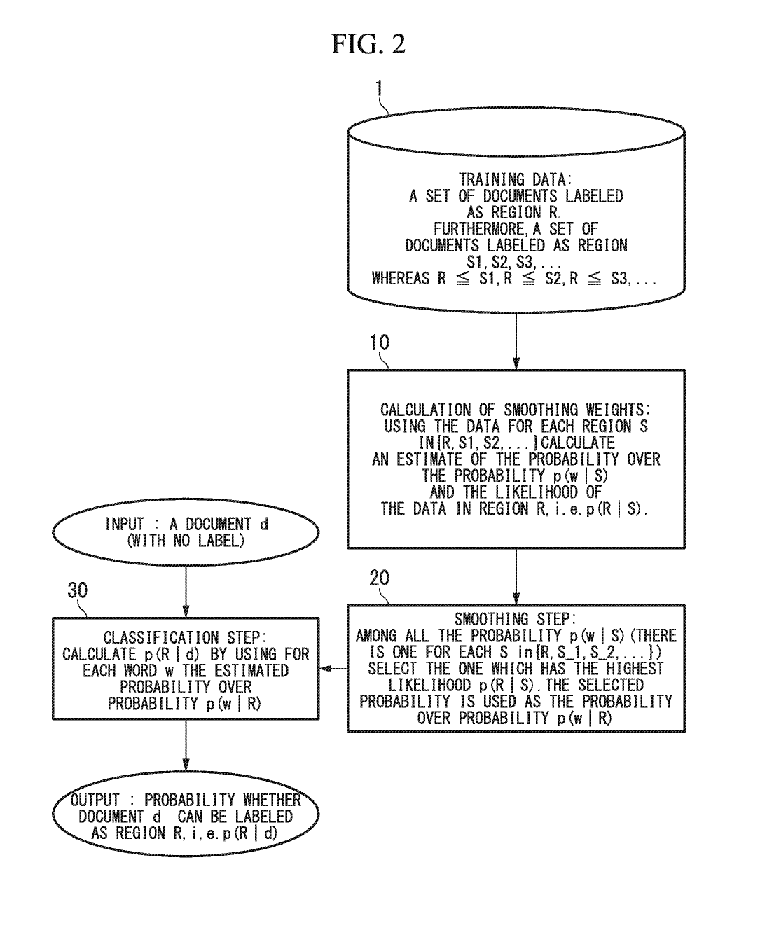

The main architecture usually performed by a computer system is described in FIG. 2. We assume we are interested in whether the text is about region R or not, which we denote by [symbol] R. Due to the analogy of geographic regions we use the term “region”, but it is clear that this can be more abstractly considered as a “category” or “class”. Further in FIG. 2, X<=Y means document set Y contains document set X.

Let θ be a vector of parameters of our model that generates all training documents D stored in a non-transitory computer storage medium 1 such as a hard disk drive. Our approach tries to optimize the probability p(D) as follows:

p(D)=∫p(D|θ)p(θ)dθ.

In the following, we will focus on p(D|θ) which can be calculated as follows:

$$p ( D \vert θ ) = {\sum }_{i ∈ D} p ( {d}_{i} , l ( {d}_{i} ) \vert θ ) = {\prod }_{i} p ( {d}_{i} \vert l ( {d}_{i} ) , θ ) \cdot p ( l ( {d}_{i} ) \vert θ )$$

where D is the training data which contains the documents {d₁, d₂, . . . }, and the corresponding label for each document dᵢ is denote l(dᵢ) (the first equality holds due to the i.i.d assumption). In our situation, l(dᵢ) is either the label saying that the document dᵢ belongs to region R, or the label saying that it does not belong to region R, i.e., l(dᵢ)ε{R, [symbol] R}.

Our model uses the naive Bayes assumption and therefore it holds:

$$\begin{matrix}{\prod }_{i} p ( {d}_{i} \vert l ( {d}_{i} ) , θ ) \cdot p ( l ( {d}_{i} ) \vert θ ) = {\prod }_{i} p ( l ( {d}_{i} ) \vert θ ) \cdot {\prod }_{w ∈ F} p ( w \vert l ( {d}_{i} ) , θ ) \\ = ( {\prod }_{i} p ( l ( {d}_{i} ) \vert θ ) ) \cdot ( {\prod }_{i} {\prod }_{w ∈ F} p ( w \vert l ( {d}_{i} ) , θ ) )\end{matrix}$$

The set of words F is our feature space. It can contain all words that occurred in the training data D, or a subset (e.g., only named entities). Our model assumes that, given a document that belongs to region R, a word w is generated by a Bernoulli distribution with probability θ_{w}. Analogously, for a document that belongs to region [symbol] R, word w is generated by a Bernoulli distribution with probability θ_{w}. That means, we distinguish here only the two cases, that is whether a word w occurs (one or more times) in a document, or whether it does not occur.

We assume that we can reliably estimate p(l(dᵢ)|θ) using a maximum likelihood approach, and therefore focus on the term ΠᵢΠ_{wεP}p(w|l(dᵢ), θ).

$${\prod }_{i ∈ D} {\prod }_{w ∈ F} p ( w \vert l ( {d}_{i} ) , θ ) = {\prod }_{w ∈ F} {θ}_{w}^{{c}_{w}} \cdot {( 1 - {θ}_{w} )}^{{n}_{R} - {c}_{w}} \cdot {ϑ}_{w}^{{d}_{w}} \cdot {( 1 - {ϑ}_{w} )}^{{n}_{R} - {d}_{w}} ,$$

where n_{R} and n [symbol] _{R} is the number of documents that belong to R, and [symbol] R, respectively; c_{w}, is the number of documents that belong to R and contain word w, analogously d_{w} is the number of documents that belong to [symbol] R and contain word w. Since we assume that the region [symbol] R is very large, that is n [symbol] _{R} is very large, we can use a maximum likelihood (or maximum a-posterior with low informative prior) estimate for θ. Therefore, our focus, is on how to estimate θ_{w}), or more precisely speaking, how to estimate the distribution p(θ_{w}).
Our choice of one θ_{w}, will affect p(D|θ) only by the factor:

θ_{w}^{c}^{_{w}}·(1−θ_{w})ⁿ^{_{R}}^{-c}^{_{w}}. (1)

This factor actually corresponds to the probability p(D_{R}|θ_{w}), where D_{R} is the set of (training) documents that belong to region R.

[Estimating p(θ_{w})]

First, recall that the probability θ_{W} corresponds to the probability p(w|R), i.e., the probability that a document that belongs to region R, contains the word w (one or more times). For estimating the probability p(θ_{w}) we use that the words were generated by a Bernoulli trial. The sample size of this Bernoulli trial is:

n_{R}:=|{d|l(d)=R}|

Using this model, we can derive the maximum likelihood estimate of p(w|R) which is:

$${ML ( p ( w \vert R ) )}_{R} = \frac{{c}_{R} ( w )}{{n}_{R}} ,$$

where we denote by c_{R}(w) the number of documents in region R that contain word w. The problem with this estimate is, that it is unreliable if n_{R} is small. Therefore, we suggest to use as an estimate a region S which contains R and is larger than or equal to R, i.e., n_{S}≧n_{R}. The maximum likelihood estimate of p(w|R) becomes:

$${ML ( p ( w \vert R ) )}_{S} = \frac{{c}_{S} ( w )}{{n}_{S}} .$$

This way, we can get a more robust estimate of the true (but unknown) probability p(w|R). However, it is obvious that it biased towards the probability of p(w|S). If we knew that the true probabilities of p(w|S) and p(w|R) are identical, then the estimate ML(p(w|R))_{S} will give us a better estimate than ML(p(w|R))_{R}. Obviously, there is a trade off when choosing S: if S is almost the same size as R, then there is a high chance that the true probability of p(w|S) and p(w|R) are identical.

However the same sample size hardly increases. On the other hand, if S is very large, there is a high chance that the true probability of p(w|S) and p(w|R) are different. This trade-off is sometimes also referred as the trade-off between specificity and reliability (see Non-Patent Document 2). Let D_{R} denote the observed documents in region R. The obvious solution to estimate p(θ_{w}) is to use p(θ_{w}|D_{R}) which is calculated by:

p(θ_{w}|D_{R})∝p(D_{R}|θ_{w})·p₀(θ_{w})

where for the prior p₀(θ_{w}) we use a beta-distribution with hyper-parameters α₀ and β₀. We can now write:

p(θ_{w}|D_{R})∝θ_{w}^{c}^{_{R}}·(1−θ_{w})ⁿ^{_{R}}^{-c}^{_{R}}·θ_{w}^{α}^{₀}⁻¹(1−θ_{w})^{β}^{₀}⁻¹,

where we wrote c_{R} short for c_{R}(w). (Also in the following, if it is clear from the context that we refer to word w, we will simply write c_{R} instead of c_{R}(w).)

However, in our situation the sample size n_{R} is small, which will result in a relatively flat, i.e., low informative distribution of θ_{w}. Therefore, our approach suggests to use S with its larger sample size n_{S} to estimate a probability distribution over θ_{w}. Let D_{S} denote the observed documents in region S. We estimate p(θ_{w}) with p(θ_{w}−D_{S}) which is calculated, analogously to p(θ_{w}|D_{S}), by:

p(θ_{w}|D_{S})∝θ_{w}^{c}^{_{S}}·(1−θ_{w})ⁿ^{_{S}}^{-c}^{_{S}}·θ_{w}^{α}^{₀}⁻¹(1−θ_{w})^{β}^{₀}⁻¹.

Making the normalization factor explicit this can be written as:

$$p ( {θ}_{w} \vert {D}_{S} ) = \frac{1}{B ( {c}_{S} + {α}_{0} , {n}_{S} - {c}_{S} + {β}_{0}} \cdot {θ}_{w}^{{c}_{S} + {α}_{0} - 1} \cdot {( 1 - {θ}_{w} )}^{{n}_{S} - {c}_{S} + {β}_{0} - 1} , \qquad ( 2 )$$

where B(α, β) is the Beta function.

Our goal is to find the optimal S, whereas we define optimal as the S≧R that maximizes the probability of the observed data (training data) D, i.e., p(D). Since we focus on the estimation of the occurrence probability in region R (i.e., θ_{w}), it is sufficient to maximize p(D_{R}) (this is because p(D)=p(D_{R})·p(D [symbol] _{R}), and p(D [symbol] _{R}) is constant with respect to θ_{w}). p(D_{R}) can be calculated as follows:

$$p ( {D}_{R} ) = {\prod }_{w} {E}_{p ( θ )} [ p ( {D}_{R} \vert {θ}_{w} , {D}_{S} ) ] = {\prod }_{w} {p}_{w} ( {D}_{R} ) ,$$

where we define E_{p(θ)}[p(D_{R}|θ_{w}, D_{S})] as p_{w}(D_{R}). In order to make it explicitly clear that we use D_{S} to estimate the probability p(θ_{w}), we write p_{w}(D_{R}|D_{S}), instead of p_{w}(D_{R}). p_{w}(D_{R}|D_{S}) is calculated as follows:

p_{w}(D_{R}|D_{S})=Eₚ₍₀₎[p(D_{R}|θ_{w}, D_{S})]=∫p(D_{R}|θ_{w}, D_{S})p(θ_{w}|D_{S})dθ_{w}=∫p(D_{R}|θ_{w})p(θ_{w}|D_{S})dθ_{w}

Using Equation (1) and Equation (2) we can write:

$${p}_{w} ( {D}_{R} \vert {D}_{S} ) = \frac{1}{B ( {c}_{S} + {α}_{0} , {n}_{S} - {c}_{S} + {β}_{0} )} \cdot \int {θ}_{w}^{{c}_{S} + {α}_{0} - 1} \cdot {( 1 - {θ}_{w} )}^{{n}_{S} - {c}_{S} + {β}_{0} - 1} \cdot {θ}_{w}^{{c}_{w}} \cdot {( 1 - {θ}_{w} )}^{{n}_{R} - {c}_{w}} d {θ}_{w}$$

Note that the latter term is just the normalization constant of a beta distribution since:

$$\int {θ}_{w}^{{c}_{S} + {α}_{0} - 1} \cdot {( 1 - {θ}_{w} )}^{{n}_{S} - {c}_{S} + {β}_{0} - 1} \cdot {θ}_{w}^{{c}_{w}} \cdot {( 1 - {θ}_{w} )}^{{n}_{R} - {c}_{w}} d {θ}_{w} = \int {θ}_{w}^{{c}_{S} + {α}_{0} - 1 + {c}_{w}} \cdot {( 1 - {θ}_{w} )}^{{n}_{S} - {c}_{S} + {β}_{0} - 1 + {n}_{R} - {c}_{w}} = B ( {c}_{S} + {α}_{0} + {c}_{w} , {n}_{S} - {c}_{S} + {β}_{0} + {n}_{R} - {c}_{w} )$$

Therefore p_{w}(D_{R}|D_{S}) can be simply calculated as follows:

$${p}_{w} ( {D}_{R} \vert {D}_{S} ) = \frac{B ( {c}_{S} + {α}_{0} + {c}_{w} , {n}_{S } - {c}_{S} + {β}_{0} + {n}_{R} - {c}_{w} )}{B ( {c}_{S} + {α}_{0} , {n}_{S} - {c}_{S} + {β}_{0} )} . \qquad ( 3 )$$

We can summarize our procedure for estimating p(θ_{w}) as follows. Given several candidates for S, i.e., S₁, S₂, S₃, . . . , we select the optimal S* for estimating p(θ_{w}) by using:

$${S}^{*} = {arg max}_{S ∈ \{ {S}_{1} , {S}_{2} , {S}_{3} , … . \}} {p}_{w} ( {D}_{R} \vert {D}_{S} ) \qquad ( 4 )$$

whereas p(D_{R}|D_{S}) is calculated using Equation (3). Note that, in general, for each word w a different outer region S is optimal. The estimate for p(θ_{w}) is then:

p(θ_{w}|D_{S*}).

The calculation of p(θ_{w}|D_{S*}) can be considered as calculating a smoothed estimate for θ_{w}, this refers to component 10 in FIG. 2; moreover choosing the optimal smoothed weight with respect to p(D_{R}|D_{S}) is referred to as component 20 in FIG. 2. A variation of this approach is to use the same outer region S, for all w, whereas the optimal region S* is selected using:

$${S}^{*} = {arg max}_{S ∈ \{ {S}_{1} , {S}_{2} , {S}_{3} , … . \}} p ( {D}_{R} \vert {D}_{S} ) = {arg max}_{S ∈ \{ {S}_{1} , {S}_{2} , {S}_{3} , … . \}} {\prod }_{w ∈ F} {p}_{w} ( {D}_{R} \vert {D}_{S} ) . \qquad ( 5 )$$

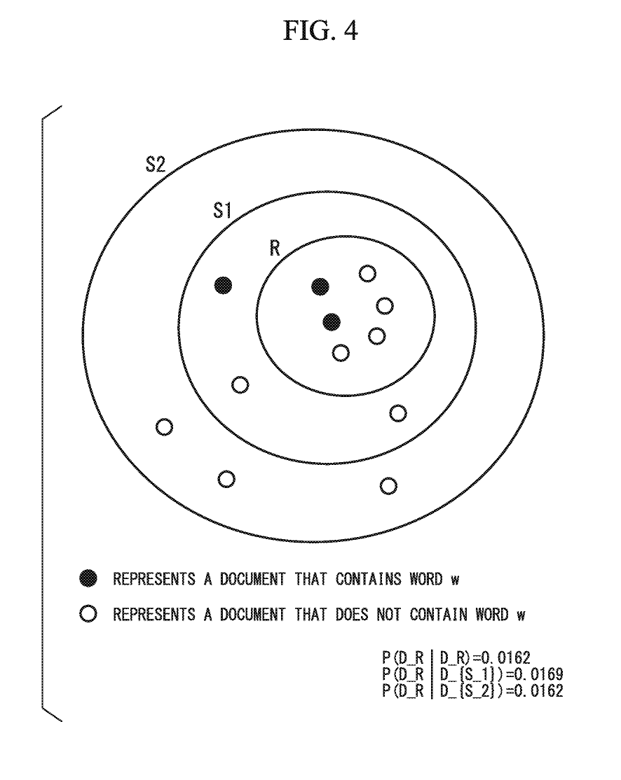

An example is given in FIG. 4.

### [Classification]

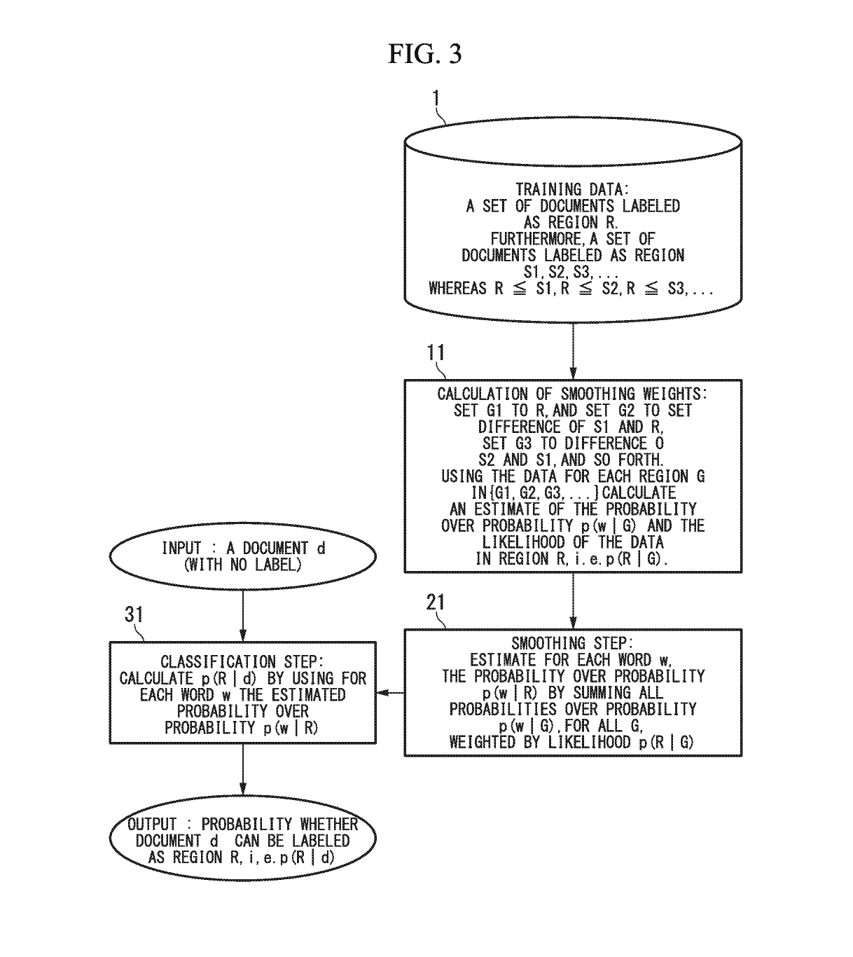

We show here how to use the estimates p(θ_{w}), for each word wεF, to decide for a new document d whether it belongs to region R or not. Note that document d is not in training data D. This corresponds to component 30 in FIG. 2 and component 31 in FIG. 3. For this classification, we use the training data D with the model, which we described above as follows:

$${arg max}_{l ∈ R , R} p ( l ( d ) = l \vert D , d )$$

The probability can be calculated as follows:

p(l(d)=l|D,d)∝p(d|D,l(d)=l)·p(l(d)=l|D)

We assume that D is sufficiently large and therefore estimate p(l(d)=l|D) with maximum-likelihood (ML) or maximum-a posterior (MAP) approach. p(d|D, l(d)=l) is calculated as follows:

p(d|D,l(d)=l)=∫p(d|θ, θ, D,l(d)=l)·p(θ, θ|D, l(d)=l)dθdθ

Where θ and θ are each vector of parameters that contains for each word w the probability θ_{w}, and θ_{w}, respectively. For l= [symbol] R we can simply use the ML or MAP for estimate for θ estimate since we assume that D [symbol] _{R} is sufficiently large.
For the case l=R we have:

$$\begin{matrix}p ( d \vert D , l ( d ) = l ) = \int p ( d \vert θ , D , l ( d ) = l ) \cdot p ( θ \vert D , l ( d ) = l ) d θ \\ = \int {\prod }_{w ∈ F} {θ}_{w}^{{d}_{w}} \cdot {( 1 - {θ}_{w} )}^{{d}_{w}} \cdot p ( {θ}_{w} \vert {S}_{w}^{*} ) d θ ,\end{matrix}$$

where S*_{w} is the optimal S for a word w that we specified in Equation (4), or we set S*_{w} independent of w to the value specified in Equation (5); d_{w} is defined to be 1, if wεd, otherwise 0.

Integrating over all possible choices of θ_{w} for calculating p(d|D, l(d)=l) is sometimes referred to as Bayesian Naive Bayes (see, for example, “Bayesian Reasoning and Machine Learning”, D. Barber, 2010, pages 208-210).

We note that instead of integrating over all possible values for θ_{w}, we can use a point-estimate of θ_{w}, like for example the following (smoothed) ML-estimated:

$${θ}_{w} := {ML ( p ( w \vert R ) )}_{{S}^{*}} = \frac{{c}_{S}^{*} ( w )}{{n}_{{S}^{*}}} .$$

### Second Exemplary Embodiment

Instead of selecting only one S for estimating p(θ_{w}), we can use region R and all its available outer-regions S₁, S₂, . . . and weight them appropriately. This idea is outlined in FIG. 3. First, assume that we are given regions G₁, G₂, . . . that are mutually exclusive. As before, our estimate for p(θ_{w}) is p(θ_{w}|D_{Gi}), if we assume that Gᵢ is the best region to use to estimate θ_{w}. The calculation of Gᵢ and p(θ_{w}|D_{Gi}) is referred to as component 11 in FIG. 3. However, in contrast to before, instead of choosing only one Gᵢ, we select all and weight them by the probability that Gᵢ is the best region to estimate θ_{w}. We denote this probability p(Gᵢ). Then, the estimate for θ_{w} can be written as:

$$p ( {θ}_{w} ) = {\sum }_{G ∈ \{ {G}_{1} , {G}_{2} , … \}} p ( {θ}_{w} \vert {D}_{G} ) \cdot p ( {D}_{G} ) \qquad ( 200 )$$

We assume that:

$${\sum }_{G ∈ \{ {G}_{1} , {G}_{2} , … \}} p ( {D}_{G} ) = 1 , \\ and$$

$$p ( {D}_{G} ) ∝ p ( {D}_{R} \vert {D}_{G} ) ,$$

where the probability p(D_{R}|D_{G}) is calculated as described in Equation (3). In words, this means, we assume that the probability that G is the best region to estimate p(θ_{w}) is proportional to the likelihood p(D_{R}|D_{G}). Recall that p(D_{R}|D_{G}) is the likelihood that we observer the training data D_{R} when we estimate p(θ_{w}) with D_{G}. The calculation of p(θ_{w}) using Equation (200) is referred to component 21 in FIG. 3.

In our setting, we have that S₁, S₂, . . . are all outer-regions of R, and thus, not mutually exclusive. Therefore we define the regions G₁, G₂, . . . as follows:

G₁:=R, G₂:=S₁\R, G₃:=S₂\S₁, G₄:=S₃\S₂, . . .

where we assume that R⊂S₁⊂S₂⊂S₃ . . . .

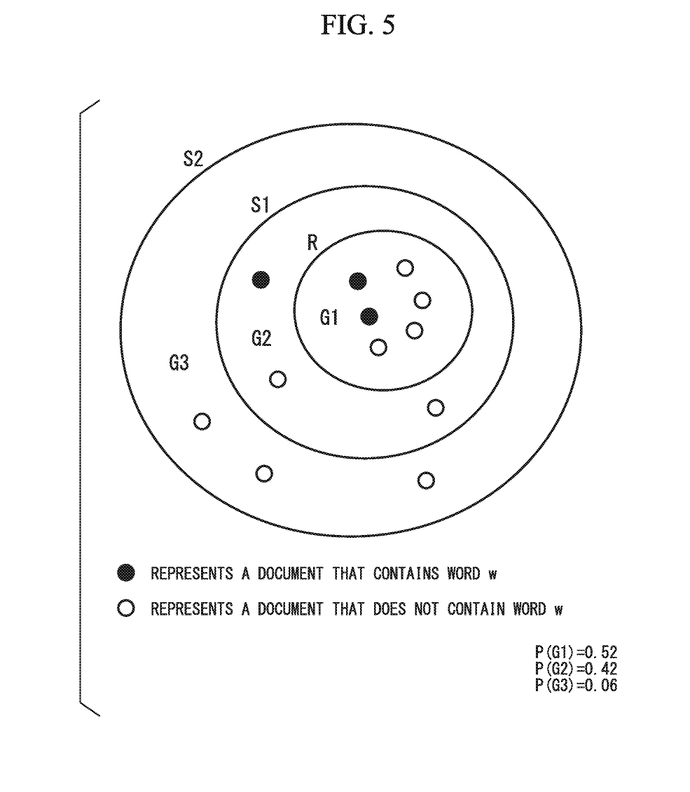

An example is given in FIG. 5 which shows the same (training) data as in FIG. 4 together with the corresponding mutual exclusive regions G₁, G₂ and G₃. G₁ is identical to R which contains 6 documents, out of which 2 documents contain the word w. G₂ contains 3 documents, out of which 1 document contains the word w. G₃ contains 3 documents, out of which no document contains the word w. Using Equation (3) we get:

p(D_{R}|D_{G}_{₁})=0.0153

p(D_{R}|D_{G}_{₂})=0.0123

p(D_{R}|D_{G}_{₃})=0.0017

And since the probabilities for p(D_{G}) must sum to 1, we get:

p(D_{G}_{₁})=0.52

p(D_{G}_{₂})=0.42

p(D_{G}_{₃})=0.06

The document classification method of the above exemplary embodiments may be realized by dedicated hardware, or may be configured by means of memory and a DSP (digital signal processor) or other computation and processing device. On the other hand, the functions may be realized by execution of a program used to realize the steps of the document classification method.

Moreover, a program to realize the steps of the document classification method may be recorded on computer-readable storage media, and the program recorded on this storage media may be read and executed by a computer system to perform document classification processing. Here, a “computer system” may include an OS, peripheral equipment, or other hardware.

Further, “computer-readable storage media” means a flexible disk, magneto-optical disc, ROM, flash memory or other writable nonvolatile memory, CD-ROM or other removable media, or a hard disk or other storage system incorporated within a computer system.

Further, “computer readable storage media” also includes members which hold the program for a fixed length of time, such as volatile memory (for example, DRAM (dynamic random access memory)) within a computer system serving as a server or client, when the program is transmitted via the Internet, other networks, telephone circuits, or other communication circuits.

### INDUSTRIAL APPLICABILITY

The present invention allows to accurately estimate whether a tweet is about a small region R or not. A tweet might report about a critical event like an earthquake, but not knowing from which region the tweet was sent, renders the information useless. Unfortunately, most Tweets do not contain geolocation information which makes it necessary to estimate the location based on the text content. The text can contain words that mention regional shops or regional dialects which can help to decide whether the Tweet was sent from a certain region R or not. It is clear that we would like keep the classification results accurate, if region R becomes small. However, as R becomes small only a fraction of training data instances become available to estimate whether the tweet is about region R or not.

Another important application is to decide whether a text is about a certain predefined class R, or not, where R is a sub-class of one or more other classes. This problem setting is typical in hierarchical text classification. For example, we would like to know whether the text belongs to class “Baseball in Japan”, whereas this class is a sub-class of “Baseball” that in turn is a sub-class of “Sports”, and so forth.

1. A document classification method comprising:
a first step for calculating smoothing weights for each word w and a fixed class R, the first step including, given a set of classes {R, S₁, S₂, . . . } where class R is subsumed by class S₁, class S₁ is subsumed by class S₂, . . . , calculating for each class S probability over probability p(w|S) representing probability that word w occurs in a document belonging to class S, and, for each of these probabilities over the probabilities p(w|S), calculating the likelihood of the training data observed in class R;
a second step for calculating smoothed second-order word probability, the second step including, among all the probabilities over the probability p(w|S) (there is one for each Sε{R, S1, S2, . . . }), selecting the one which results in the highest likelihood of the data as calculated in the second step before, the selected probability being used as the smoothed second-order word probability for p(w|R); and
a third step for classifying document including calculating the probability that the document belongs to the class R by using the smoothed second-order word probability to integrate over all possible choices of p(w|R), or by using the maximum a-posteriori estimate of the smoothed estimated of p(w|R).

2. The document classification method according to claim 1, wherein the first step further includes denoting R as G₁, denoting set differences of the documents in R and S₁ as G₂, denoting set difference of the documents in S₁ and S₂ as G₃, . . . , for each G in {G₁, G₂, G₃, . . . }, calculating the probability over the probability p(w|G) representing probability that word w occurs in a document belonging to document set G, and for each of these probabilities over the probabilities p(w|G), calculating the likelihood of the training data observed in class R; and
the second step further includes calculating smoothed second-order word probabilities including calculating the probability over the word probability p(w|R) by using the weighted sum of the probabilities of the probability p(w|G) calculated in the step before, where the weights correspond to the likelihoods calculated in the step before.
